(19) United States
(12) Patent Application Publication
(10) Pub. No.: US 2011/0181006 A1
(43) Pub. Date: Jul. 28, 2011

(54) TRAILER CONVERTIBLE TO A SLED

(76) Inventor: Alden Heppner, Lac La Biche (CA)

(21) Appl. No.: 12/961,372

(22) Filed: Dec. 6, 2010

(30) Foreign Application Priority Data
Jan. 27, 2010 (CA) 2691122

(51) Int. Cl. B62B 13/18

(52) U.S. Cl. 280/9

(57) ABSTRACT

A trailer convertible to a sled uses a drop axle, which is mounted for rotation. The drop axle has a sled mode and a trailer mode. Upon rotation of a primary shaft of the drop axle in a first direction, ski supports lower skis into the sled mode and secondary shafts supporting wheels are raised. Upon rotation of the primary shaft of the drop axle in a second direction, the ski supports raise the skis and the secondary shaft supporting wheels are lowered to the trailer mode. A lock is provided for locking the drop axle in a selected one of the sled mode or the trailer mode.

### FIELD

There is described a wheeled trailer with retractable skis that can be lowered to convert the trailer into a sled.

### BACKGROUND

U.S. Pat. No. 3,730,542 (Chadwick) entitled “Convertible Trailer” describes a wheeled trailer with retractable skiis that can be lowered in order to convert the trailer into a sled. There will hereinafter be described an alternative and improved structure for obtaining this result.

### SUMMARY

There is provided a trailer convertible to a sled, which includes a trailer chassis having a front end and a rear end. A hitch is positioned at the front end of the chassis. A drop axle is mounted for rotation at the rear end of the chassis. The drop axle has a primary shaft defining a primary axis. Radial arms extend radially from each of opposed ends of the primary shaft and a secondary shaft projecting outwardly from a remote end of each radial arm. The secondary shafts define a secondary axis which is parallel to the primary axis. Wheels are mounted on the secondary shafts for rotation about the secondary axis. Ski supports are secured in spaced relation to the primary shaft. Skis are pivotally secured to each of the ski supports.

The drop axle has a sled mode and a trailer mode. Upon rotation of the primary shaft of the drop axle in a first direction, the ski supports lower the skis into the sled mode and the secondary shaft and wheels are raised. Upon rotation of the primary shaft of the drop axle in a second direction, the ski supports raise the skis and the secondary shaft and wheels are lowered to the trailer mode. A lock is provided for locking the drop axle in a selected one of the sled mode or the trailer mode.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a trailer convertible to a sled in a trailer mode.

FIG. 2 is a perspective view of the trailer convertible to a sled of FIG. 1, in the sled mode.

FIG. 3 is a detailed perspective view of an axle safety lock for the trailer convertible to a sled of FIG. 1, in the trailer mode.

FIG. 4 is a perspective view of a drop axle lock for the trailer convertible to a sled of FIG. 1, shown in the trailer mode.

FIG. 5 is a perspective view of the drop axle lock for the trailer convertible to a sled of FIG. 4, shown in the sled mode.

FIG. 6 is a side elevation view of the back end of the trailer being lifted by a screw jack.

FIG. 7 is a simplified front elevation view of the drop axle in the sled mode.

FIG. 8 is a simplified front elevation view of the drop axle of FIG. 7, in the trailer mode.

FIG. 9 is a side elevation view of the drop axle safety lock.

FIG. 10 is a simplified perspective view of the axle rotation arm with wheel removed, in trailer mode.

FIG. 11 is a simplified perspective view of the axle rotation arm with wheel removed, in sled mode.

### DETAILED DESCRIPTION

A trailer convertible to a sled generally identified by reference numeral 10 will now be described with reference to FIG. 1 through 11.

### Structure And Relationship of Parts

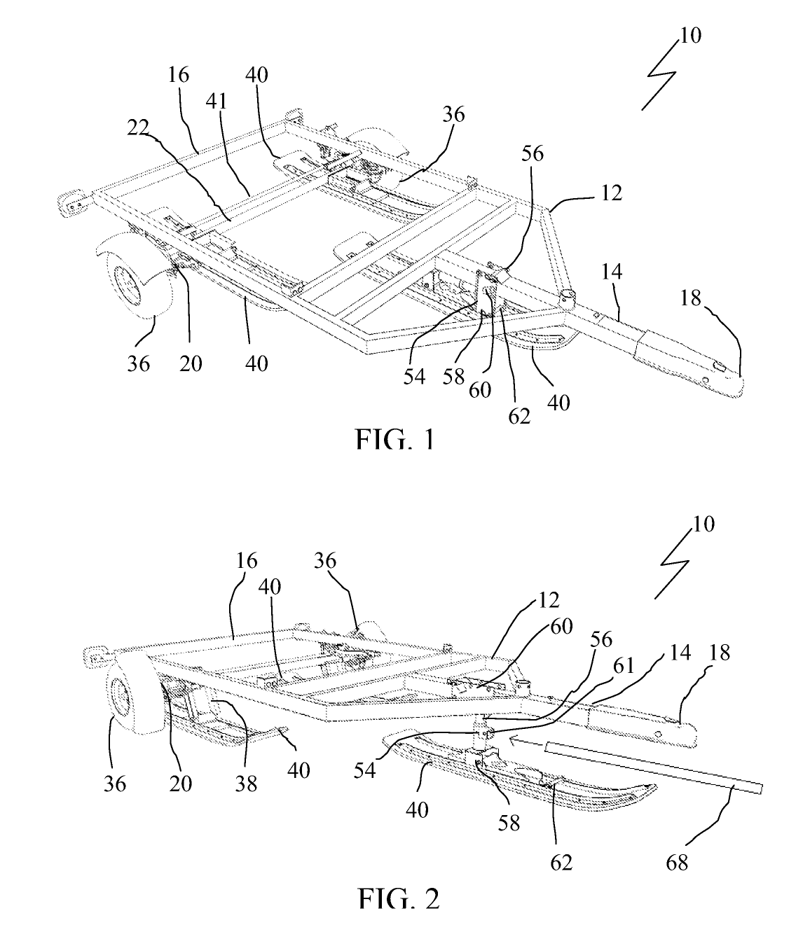

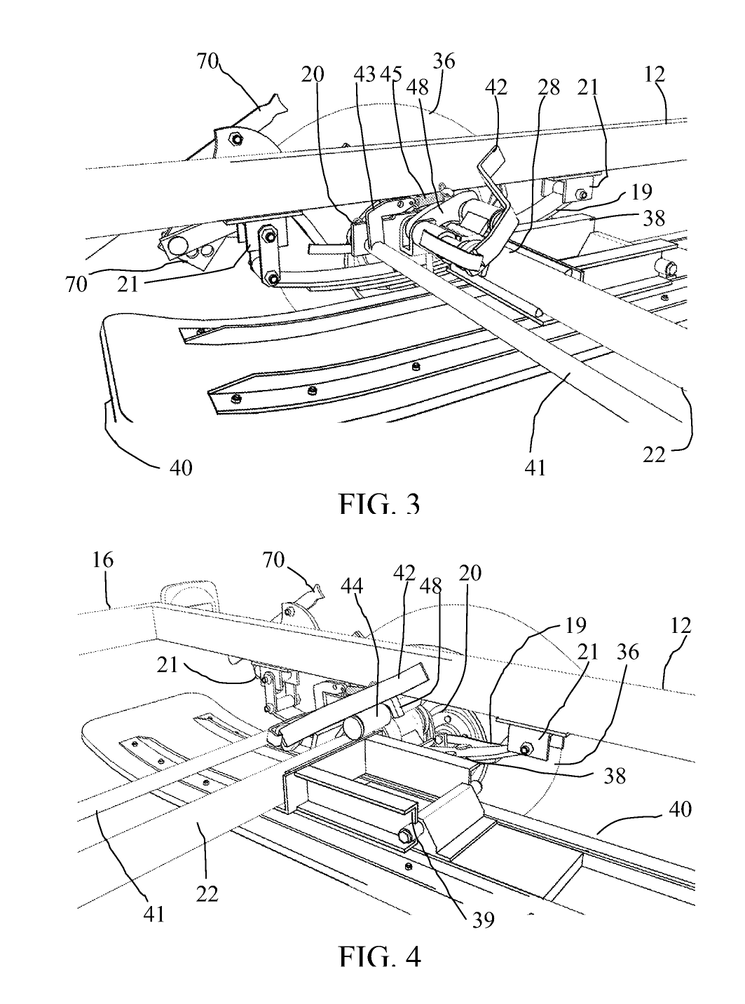

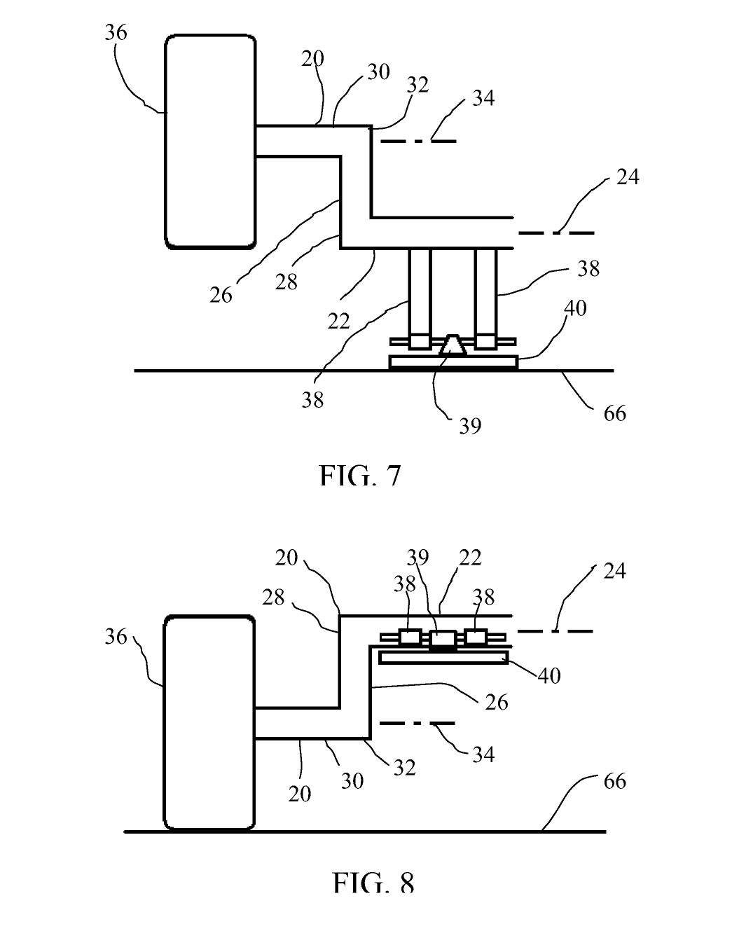

Referring to FIG. 1 and FIG. 2, a trailer convertible to a sled 10 includes a trailer chassis 12, which has a front end 14 and a rear end 16. A hitch 18 is positioned at front end 14 of chassis 12 and a drop axle 20 is mounted for rotation at rear end 16 of chassis 12. Referring to FIGS. 3 and 9, drop axle 20 is supported by a spring suspension 19, which is connected to chassis 12 by connections 21. Referring to FIG. 7 and FIG. 8, drop axle 20 has a primary shaft 22, which defines a primary axis 24 and radial arms 26 which extend radially from each of opposed ends 28 of the primary shaft 22. A secondary shaft 30 projects outwardly from a remote end 32 of each radial arm 26. Secondary shafts 30 define a secondary axis 34, which is parallel to primary axis 24. Wheels 36 are mounted on secondary shafts 30 for rotation about secondary axis 34 and ski supports 38 are rigidly fixed in spaced relation to primary shaft 22. Skis 40 are secured to each ski support 38 by a pivotal mount 39.

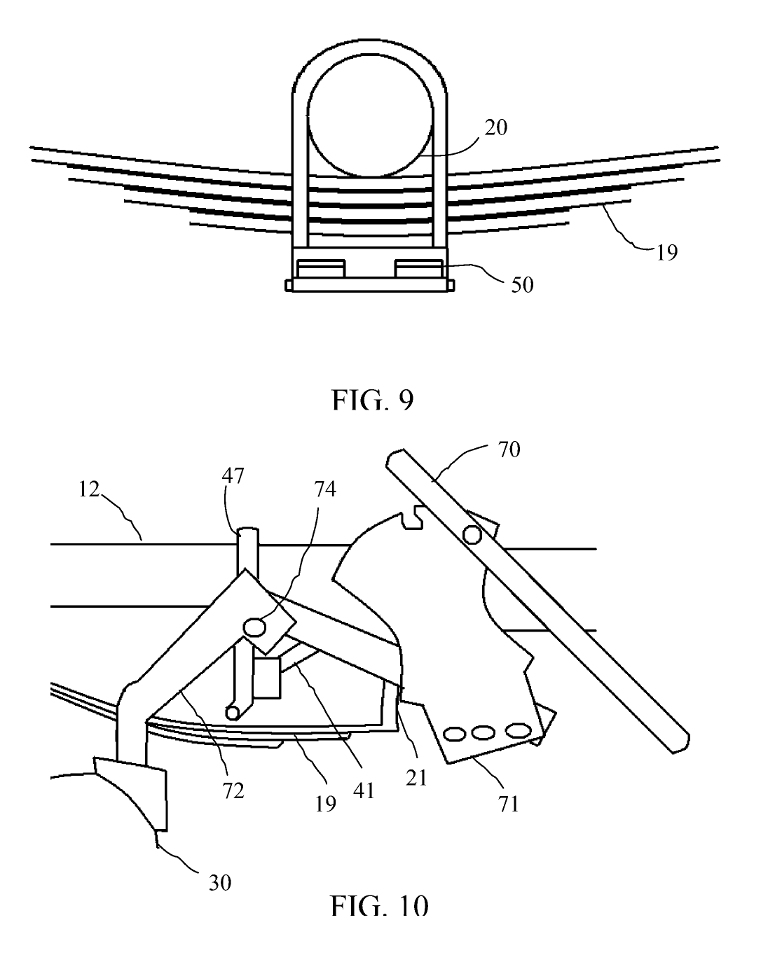

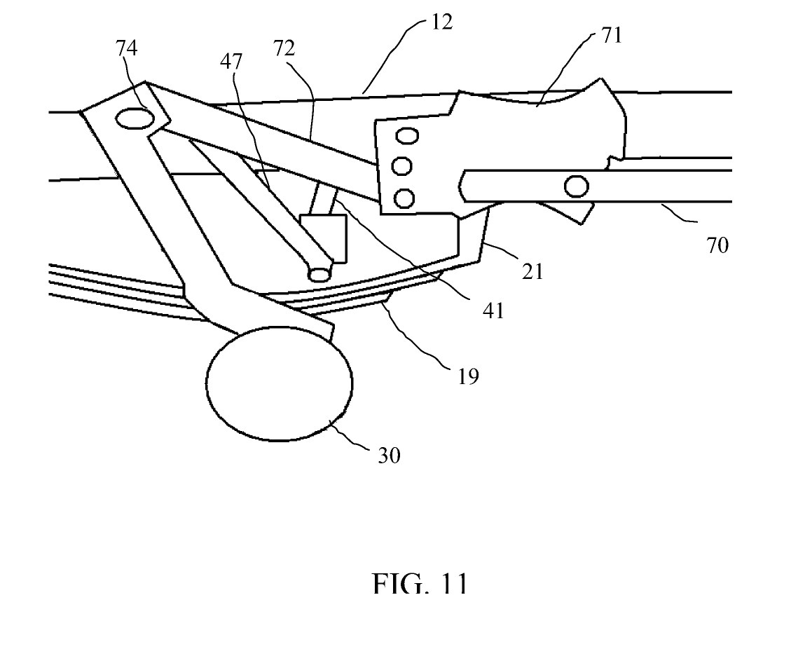

Drop axle 20 has a sled mode, shown in FIG. 2 and FIG. 7, and a trailer mode, shown in FIG. 1 and FIG. 8. Referring to FIG. 7 rotation of the primary shaft 22 of the drop axle 20 in a first direction causes the ski supports 38 to lower the skis 40 into the sled mode and the secondary shaft 30 and wheels 36 to be raised. Referring to FIG. 8, rotation of the primary shaft 22 of the drop axle 20 in a second direction causes the ski supports 38 to raise the skis 40 and secondary shaft 30 and wheels 36 to be lowered to the trailer mode. Referring to FIG. 10 and FIG. 11, an axle rotation lever 70 is attached to an axle rotation body 71 which acts upon an axle rotation linkage 72 to mechanically rotate drop axle 20. Referring to FIG. 10 axle rotation linkage 72 is shown in the trailer mode position. Referring to FIG. 11, axle rotation linkage 72 is shown in the sled mode position. Axle rotation linkage 72 is connected to secondary shaft 30 and bends at pivot point 74.

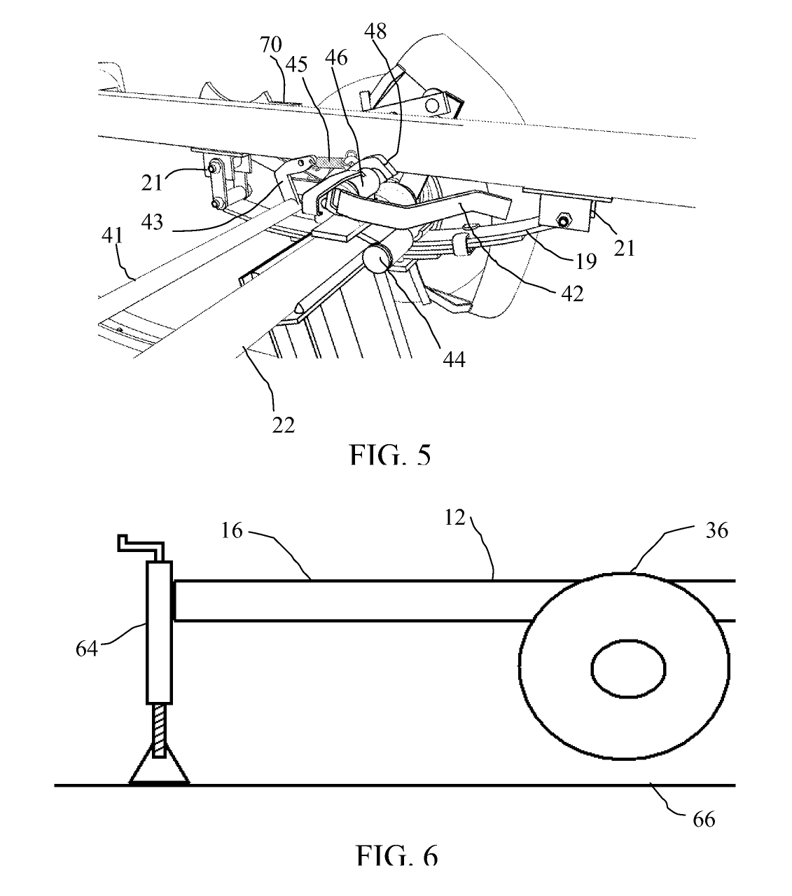

Referring to FIG. 3 through FIG. 5, a lock is provided for locking drop axle 20 in either sled mode or trailer mode. Lock includes a first pin 44 and a second pin 46 secured in circumferential spaced relation parallel to the primary shaft 22. Pivotal locking dogs 48 are provided on both sides of trailer chassis 12 to engage first pin 44 to lock drop axle 20 in trailer mode as shown in FIG. 4 or engage second pin 46 to lock drop axle 20 in sled mode, shown in FIG. 5. A mechanism is provided which moves pivotal locking dogs 48 on both sides of trailer chassis 12 between engaged and disengaged positions. A rotating shaft 41 is provided with radially projecting fingers 43. A spring 45 extends from each of fingers 43 to each locking dog 48. Referring to FIG. 10, a locking dog lever 47 rotates shaft 41. Referring to FIG. 5, as shaft 41 rotates a force is exerted upon locking dogs 48 to move them to the release position. Drop axle 20 is free to rotate when locking dogs 48 are disengaged from both first pin 44 and second pin 46. Second pin 46 is axially movable to provide clearance during rotation of primary shaft 22. Second pin 46 is moved axially by pulling on handle 42. Referring to FIG. 9, a trailer mode safety lock 50 pivots about a substantially horizontal pivot axis between a locking and release position. The locking position is used in the trailer mode. In the locking position, the safety lock 50 is positioned on opposed sides of radial arms 26 of drop axle 20 to prevent rotational movement should the wheel strike an object resulting in an impact being transmitted to drop axle 20.

Referring to FIG. 1, a front ski support 54 is mounted to front end 14 of trailer chassis 12. Front ski support 54 has a chassis mounting end 56 and a ski supporting end 58. Chassis mounting end 56 is pivotally mounted at front end 14 of the chassis 12 for movement between a stored pivotal position and an operative pivotal position. A socket 61 is provided which is capable of accepting a steering bar 68 to allow for steering of front ski support 54. Referring to FIG. 2, in the operative pivotal position, ski support 54 is pinned to the chassis 12 by locking pins 60 in a substantially vertical orientation. Referring to FIG. 1. in the stored pivotal position, ski support 54 is pinned to the chassis 12 by locking pins 60 in a substantially horizontal orientation parallel to chassis 12. A ski 40 is pivotally mounted to ski supporting end 56 of ski support 54. When ski support 54 is in the stored pivotal position, a locking pin 62 is used to pin ski 40 to ski support 54 to prevent pivotal movement of ski 40 relative to ski support 54.

Referring to FIG. 6, a screw jack 64 is attached, either permanently or in a removable fashion, to rear end 16 of trailer chassis 12. Screw jack 64 is utilized to lift tire 36 off the ground 66 to allow for conversion of trailer 10 from trailer mode to sled mode and vice versa.

### Operation

Referring to FIG. 1, trailer convertible to a sled 10 is in trailer mode. Referring to FIG. 6, screw jack 64 is used to elevate wheel 36 off the ground 66. Referring to FIG. 9, safety lock 50 is disengaged to allow rotational movement of drop axle 20. Referring to FIG. 4, locking dog lever 47, shown in FIG. 10, acts to rotate shaft 41 to pivot locking dogs 48 to a disengaged position disengaged from first pin 44 which allows rotation of primary shaft 22. Referring to FIG. 11, rotation of primary shaft 22 is accomplished by exerting a force upon axle rotation lever 70 to cause axle rotation linkage 72 to move drop axle 20 from the trailer mode to the sled mode. Referring to FIG. 7, rotation of primary shaft 22 causes ski supports 38 to lower skis 40 to a ground engaging position while secondary shaft 30 and wheels 36 are raised. Referring to FIG. 5, handle 42 is used to push second pin 46 axially into an operative position. Referring to FIG. 11, locking dog lever 47 causes shaft 41 to be rotated causing movement of pivotal locking dogs 48. Referring to FIG. 5, pivotal locking dogs 48 are pivoted to engage second pin 46 to hold trailer in sled mode. Referring to FIG. 6, screw jack 64 is released to put skis 40 in a ground engaging position. Front of chassis 12 is then lifted with screw jack 64 in preparation for lowering the front ski. Referring to FIG. 1, locking pins 60 are removed and ski support 54 is moved from the stored position into the operative position. Ski support 54 is then locked in place by locking pins 60. Locking pin 62 is removed to allow for pivotal movement of ski 40 relative to ski support 54. Socket 61 is provided with a steering bar 68 to allow for steering of the front ski.

Referring to FIG. 2, trailer convertible to a sled 10 is in sled mode. Referring to FIG. 6, screw jack 64 is used to take the weight of rear end 16 off the ground 66. Referring to FIG. 11, locking dog lever 47 acts to rotate shaft 41 to pull pivotal locking dogs 48 on both sides of chassis 12 to the release position. Referring to FIG. 5, once pivotal locking dogs 48 are disengaged from second pin 46 it allows rotation of primary shaft 22. Handle 42 is used to pull second pin 46 axially out of the way. Referring to FIG. 10, axle rotation lever 70 activates axle rotation linkage 72 to pivot drop axle 20 from the sled mode into the trailer mode. Referring to FIG. 3, rotation of primary shaft 22 causes ski supports 38 to raise skis 40 while secondary shaft 30 and wheels 36 are lowered. Referring to FIG. 10, locking dog lever 47 rotates shaft 41 to re-engage locking dogs 48. Referring to FIG. 3, locking dogs 48 engage first pin 44 to hold trailer in trailer mode. Safety lock 50 is engaged to prevent rotational movement of drop axle 20. Referring to FIG. 6, screw jack 64 is released to allow wheels 36 to engage the ground. Similar to screw jack 64 shown in FIG. 6, a front screw jack is then utilized to take weight off front ski 40. Referring to FIG. 1, ski support 54 is moved from an operative position to a stored position by removing locking pins 60 and moving ski support 54 into stored position. Ski support 54 is locked in place by locking pins 60. Locking pin 62 is engaged to prevent pivotal movement of ski 40 relative to ski support 54.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A trailer convertible to a sled, comprising:
a trailer chassis having a front end and a rear end;
a hitch positioned at the front end of the chassis;
a drop axle mounted for rotation at the rear end of the chassis, the drop axle having a primary shaft defining a primary axis, radial arms extending radially from each of opposed ends of the primary shaft and a secondary shaft projecting outwardly from a remote end of each radial arm, the secondary shafts defining a secondary axis which is parallel to the primary axis;
wheels mounted on the secondary shafts for rotation about the secondary axis;
ki supports secured in spaced relation to the primary shaft;
skis pivotally secured to each of the ski supports;
the drop axle has a sled mode and a trailer mode, upon rotation of the primary shaft of the drop axle in a first direction, the ski supports lower the skis into the sled mode and the secondary shaft and wheels are raised, upon rotation of the primary shaft of the drop axle in a second direction, the ski supports raise the skis and the secondary shaft and wheels are lowered to the trailer mode; and
a lock is provided for locking the drop axle in a selected one of the sled mode or the trailer mode.

2. The trailer convertible to a sled of claim 1, wherein the lock includes a first pin and a second pin secured in circumferential spaced relation parallel to the primary shaft, a pivotal locking dog being provided to engage the first pin to lock the drop axle in the sled mode and engage the second pin to lock the drop axle in the trailer mode, the drop axle being free to rotate when the locking dog is disengaged from both the first pin and the second pin.

3. The trailer convertible to a sled of claim 2, wherein one of the first pin or the second pin is axially movable to provide clearance during rotation of the primary shaft.

4. The trailer convertible to a sled of claim 1, wherein a trailer mode safety lock is provided that pivots between a locking and release position, in the locking position the safety lock has stop members that are positioned on opposed sides of the radial arms of the drop axle to prevent rotational movement.

5. The trailer convertible to a sled of claim 1, wherein a ski support is provided having a chassis mounting end and a ski supporting end, the chassis mounting end is pivotally mounted at the front end of the chassis for movement between a stored pivotal position and an operative pivotal position, in the operative pivotal position the ski support is pinned to the chassis by locking pins in a substantially vertical orientation, in the stored pivotal position the ski support is pinned to the chassis by locking pins in a substantially horizontal orientation, a ski is pivotally mounted to the ski supporting end of the ski support, when the ski support is in the stored pivotal position a locking pin is used to pin the ski to the ski support to prevent pivotal movement of the ski relative to the ski support.

6. The trailer convertible to a sled of claim 1, wherein an axle rotation linkage is provided to rotate the drop axle between the trailer mode and the sled mode.

7. A trailer convertible to a sled, comprising:
a trailer chassis having a front end and a rear end;
a hitch positioned at the front end of the chassis;
a drop axle mounted for rotation at the rear end of the chassis, the drop axle having a primary shaft defining a primary axis, radial arms extending radially from each of opposed ends of the primary shaft and a secondary shaft projecting outwardly from a remote end of each radial arm, the secondary shafts defining a secondary axis which is parallel to the primary axis;
wheels mounted on the secondary shafts for rotation about the secondary axis;
ski supports secured in spaced relation to the primary shaft;
skis pivotally secured to each of the ski supports;
the drop axle has a sled mode and a trailer mode, upon rotation of the primary shaft of the drop axle in a first direction, the ski supports lower the skis into the sled mode and the secondary shaft and wheels are raised, upon rotation of the primary shaft of the drop axle in a second direction, the ski supports raise the skis and the secondary shaft and wheels are lowered to the trailer mode;
an axle rotation linkage to rotate the drop axle between the trailer mode and the sled mode;
a lock is provided for locking the drop axle in a selected one of the sled mode or the trailer mode, the lock includes a first pin and a second pin secured in circumferential spaced relation parallel to the primary shaft, a pivotal locking dog being provided to engage the first pin to lock the drop axle in the sled mode and engage the second pin to lock the drop axle in the trailer mode, the drop axle being free to rotate when the locking dog is disengaged from both the first pin and the second pin, the second pin is axially movable to provide clearance during rotation of the primary shaft;
a trailer mode safety lock pivots between a locking and release position, in the locking position the safety lock has stop members that are positioned on opposed sides of the radial arms of the drop axle to prevent rotational movement; and
a ski support having a chassis mounting end and a ski supporting end, the chassis mounting end is pivotally mounted at the front end of the chassis for movement between a stored pivotal position and an operative pivotal position, in the operative pivotal position the ski support is pinned to the chassis by locking pins in a substantially vertical orientation, in the stored pivotal position the ski support is pinned to the chassis by locking pins in a substantially horizontal orientation, a ski is pivotally mounted to the ski supporting end of the ski support, when the ski support is in the stored pivotal position a locking pin is used to pin the ski to the ski support to prevent pivotal movement of the ski relative to the ski support.
